(19) United States
(12) Patent Application Publication
(10) Pub. No.: US 2016/0282314 A1
(43) Pub. Date: Sep. 29, 2016

(54) WALK-BEHIND RAIL CONDITION MONITORING APPARATUS

(71) Applicant: NORDCO INC., Oak Creek, WI (US)

(72) Inventors: Jens HUPKAU, Cheshire, CT (US); Philip EDWARDS, II, Bridgeport, CT (US)

(21) Appl. No.: 15/074,620

(22) Filed: Mar. 18, 2016

Related U.S. Application Data
(60) Provisional application No. 62/137,051, filed on Mar. 23, 2015.

(51) Int. Cl. G01N 29/265; G01N 29/22; B61L 23/04

(52) U.S. Cl. CPC G01N 29/265; B61L 23/04; G01N 29/226; G01N 2291/0234; G01N 2291/0289; G01N 2291/2623

(57) ABSTRACT

A walk-behind rail condition monitoring apparatus is provided, including a frame; at least one handle on the frame; a processor mounted to the frame; a couplant tank mounted to the frame; and a rail capture unit mounted to the frame. The rail capture unit is constructed and arranged for retaining an ultrasonic sensing wheel and including a plurality of rotating guides for maintaining alignment of the monitor on a railroad rail.

### RELATED APPLICATION

This application claims 35 USC 119(e) priority from U.S. Provisional Application Ser. No. 62/137,051 filed Mar. 23, 2015.

### BACKGROUND

The present invention relates generally to railroad rail condition monitoring systems, and more specifically, to an improved, compact rail condition monitor constructed and arranged for monitoring a single rail as an operator walks behind the unit.

Monitoring of the condition of railroad rails to monitor cracks, defective couplings and the like using ultrasonic technology is known in the art. In one embodiment, a conventional utility truck is provided with retractable rail travel wheels, and has an operator workstation, where an operator monitors data obtained by an ultrasonic sensing unit in contact with the rail. Such systems are disclosed in commonly-assigned, copending US Patent Publication Nos. 2013/0231873-A1 and 2014/0069193-A1, both of which are incorporated by reference.

There is a need by railroads for a smaller scale rail condition monitoring system for use in rail yards, for short distances, and in other locations where a large vehicle is too expensive, impractical or otherwise unsuitable. Walk-behind rail maintenance systems are available. Also, conventional systems require the operator to wear components on his body in a backpack, which is heavy and in some cases difficult to access. Thus, there is a need for an improved walk-behind rail condition monitoring apparatus that is more ergonomically suitable to the operator.

### SUMMARY

The above-listed needs are met or exceeded by the present walk-behind rail condition monitoring apparatus, which features many system components integrated into a single housing that easily pushed along the rail by an operator. A six-point rail engagement provides greater stability and accuracy. The multi-point engagement includes pairs of biased rollers which ride on each side of the rail head, and which are constructed and arranged to pivot clear of the rail head if an obstruction is encountered. Such obstructions include but are not limited to switches or rail crossings. During operation, the rollers provide increased stability for the apparatus, and facilitate the maintenance of operational alignment of the apparatus as the operator walks along the track. Also, the present configuration is more adaptable to varying cross-sections of rail and variations in real head geometry due to wear. The rollers are optionally retractable by the operator.

Another feature of the present monitoring apparatus is an enhanced, on-board DSP (Digital Signal Processor) technology which incorporates software for both A-Scan (oscilloscope display) and B-Scan (colored icons represent rail condition and alert the operator of flaws) technology. Further, the processor is equipped with GPS capability. Included in the processor software are liquid acoustic couplant flow control functions that control a couplant flow pump to adjust the couplant flow patterns in view of operating and/or environmental conditions. The operator can control the couplant flow output through a Graphic User Interface (GUI) on the processor. When the operator pauses in monitoring, the unit features a retractable blade stand to hold the apparatus upright on the rail, or alternately, on the ground. As is known in the art, the couplant is sprayed upon the rail near the ultrasonic transducer for accurate ultrasonic data retrieval.

Other features include a storage area on an upper surface of the couplant tank for storing an ethernet cable, an adjustable push handle to accommodate a variety of operators, a detachable side handle that mounts left or right for more convenient pushing while the operator walks alongside the unit, a retract lever for disengaging the multi-point rail capture system, a quick connect tool-less battery coupling.

More specifically, a walk-behind rail condition monitoring apparatus is provided, including a frame; at least one handle on the frame; a processor mounted to the frame; a couplant tank mounted to the frame; and a rail capture unit mounted to the frame. The rail capture unit is constructed and arranged for retaining an ultrasonic sensing wheel and including a plurality of rotating guides for maintaining alignment of the monitor on a railroad rail.

In another embodiment, a walk-behind rail condition monitoring apparatus, is provided, including a frame; at least one handle on the frame; a processor mounted to the frame, the processor having a GUI display, is programmed for providing both A-Scan and B-Scan data, and has GPS. A couplant tank is mounted to the frame; and a rail capture unit is mounted to the frame, is constructed and arranged for retaining an ultrasonic sensing wheel and including a plurality of rotating guides for maintaining alignment of the monitor on a railroad rail.

### BRIEF DESCRIPTION OF THE DRAWINGS

FIG. 1 is a rear perspective view of the present walk-behind rail condition monitoring apparatus;

FIG. 2 is a rear view of the apparatus of FIG. 1;

FIG. 3 is a side elevation of the apparatus of FIG. 1;

FIG. 4 is a fragmentary front view of the apparatus of FIG. 1, showing the rail capture assembly;

FIG. 5 is a side view of the present rail capture assembly showing the retractable guide wheels in operational and retracted positions;

FIG. 6 is a front view of the assembly of FIG. 5;

FIG. 7 is a side view of the present rail capture assembly in an operational position;

FIG. 8 is a side view of the assembly of FIG. 7 with the guide wheels shown moving from the operational position to the retracted position;

FIG. 9 is a schematic of the present GUI of the couplant flow control system; and

FIG. 10 is a schematic flow chart of the control system operated by the GUI of FIG. 9.

### DETAILED DESCRIPTION

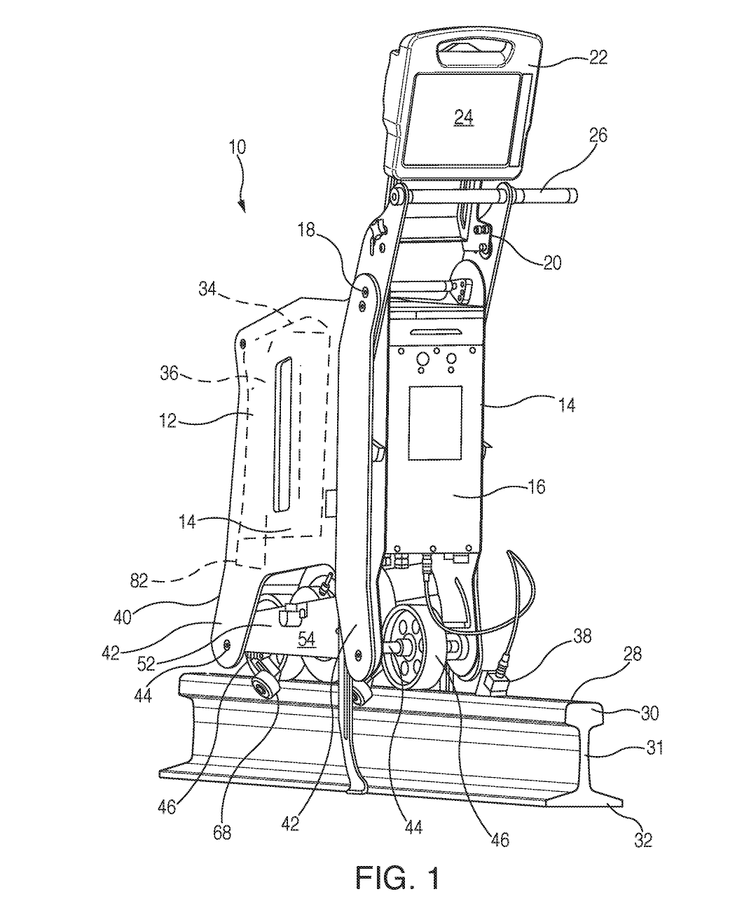

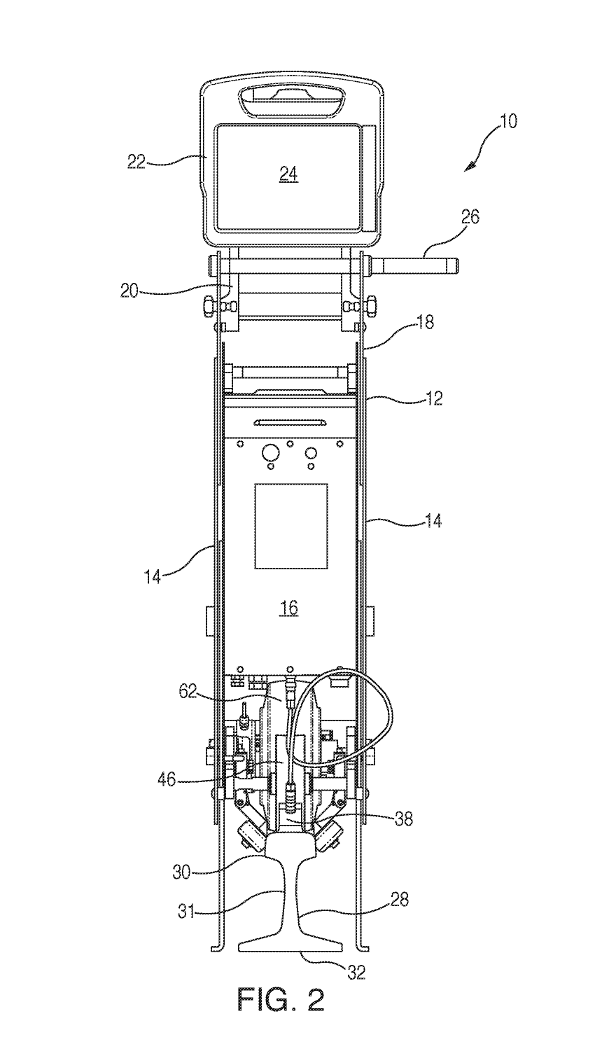

Referring now to FIGS. 1-3, the present walk-behind rail condition monitoring apparatus is generally designated 10, including a generally rectangular frame 12 made of a pair of laterally spaced sidewalls 14 and a rear wall 16. Attached to the frame 12 at an upper end 18 is a processor support bracket 20 accommodating a computer laptop-type processor 22. While other computers are considered suitable, a preferred unit is a Panasonic CF-H2 Toughbook touch screen with integrated GPS. The bracket 20 is constructed and arranged to permit the operator to adjust the position and angular orientation of the processor 22 relative to the frame 12. As is known in the art, the processor 22, also referred to as a Digital Signal Processor (DSP) includes a Graphical User Interface (GUI) display 24, which preferably incorporates a touch screen.

Also located on the processor support bracket 20 is a laterally slidable push handle 26 that permits the operator to walk beside the apparatus on either side as it rides on a rail 28 of a railroad track. As is known in the art, the rail 28 includes a head 30, a web 31 and a flared foot 32. The handle 26 is lockable in either of a right or left push position.

Defined by the side and rear walls 14, 16 is a chamber 34 (shown hidden) accommodating a couplant tank 36 (also hidden). As is known in the art, the couplant is typically water, but in cold weather, additives, such as windshield washer fluid, are incorporated to prevent freezing A pump (not shown) on the frame 12 is in communication with the couplant tank 36 and distributes couplant to the rail 28 via a spray nozzle (explained below) to enhance ultrasonic data transmission. A hand held transducer 38, also called a handset is provided for an operator to perform hand testing.

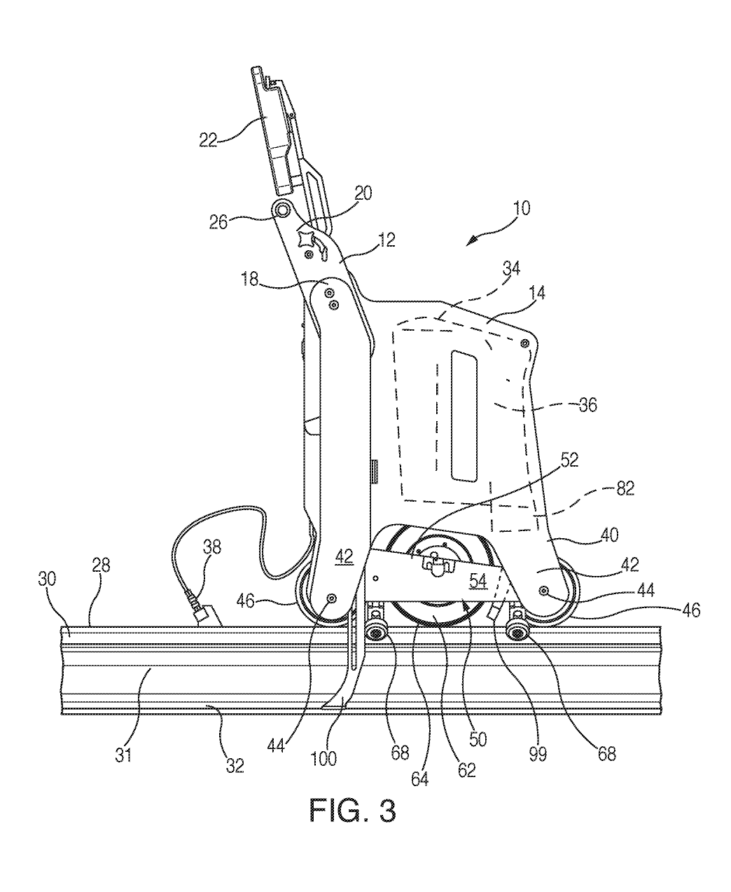

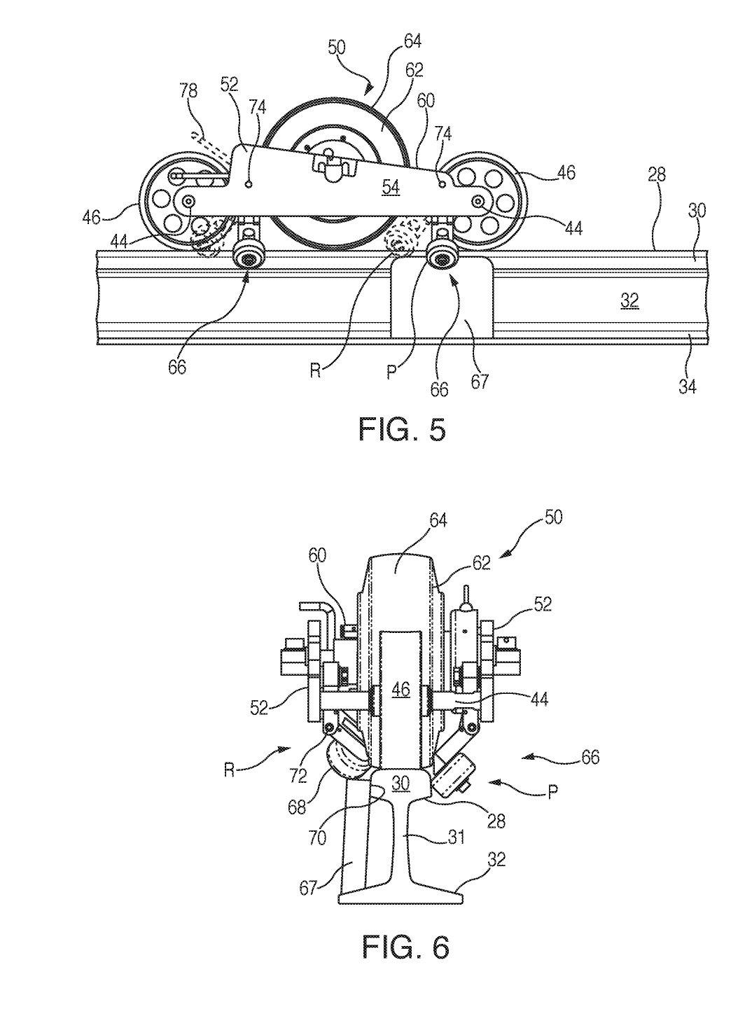

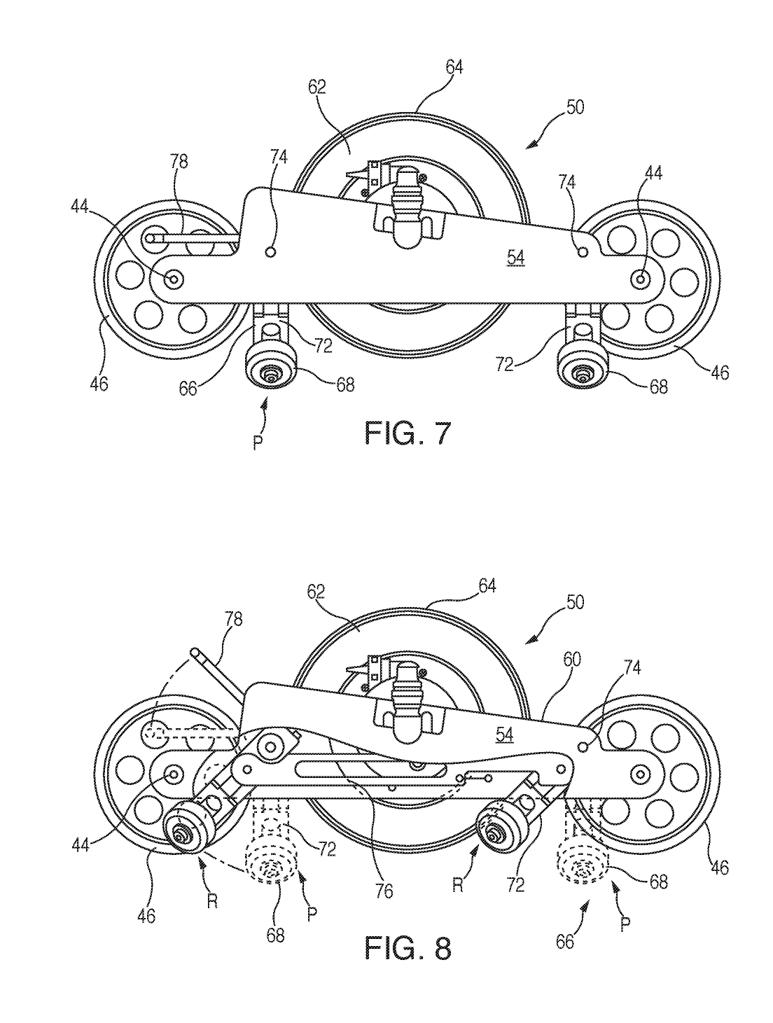

Referring now to FIGS. 3-8, opposite the upper end 18 of the frame 12 is a lower end 40, having four prongs 42. An axle 44 is mounted transversely between each opposed pair of prongs, and rotatably accommodates a guide wheel 46, two of which are provided. Also attached to the prongs 42 at the same point as the axles 44 is a rail capture assembly, generally designated 50. A sensor bracket 52 includes a pair of laterally spaced plates 54 each connected at front and rear ends 56, 58 to the axles 44. The plates 54 define a space 60 in which an ultrasonic sensor wheel 62 is rotatably retained so that a membrane 64 of the wheel is in contact with the rail head 30. Such sensor wheels are well known in the art, and in the preferred embodiment, the wheel 62 is an XL9/11 Lite model with 11 sensing channels and a direct encoder. As is also known in the art, the sensor wheel 62 transmits sensed data on rail condition to the processor 22. The transmission is through a cable (not shown) or wirelessly. Software in the processor 22 is configured to receive the sensed signals from the wheel 62 and to display both A-Scan and B-Scan rail condition data, the latter including real-time analysis expressed as color coded rail condition indicating icons as described in commonly-assigned US Publication No. 2013/0231873-A1 which is incorporated by reference.

Another feature of the present apparatus 10 is that while the sensor wheel 62 is provided with eleven sensors and sensor channels, as known in the art, the processor 22 is provided with a 12^{th} sensing channel for operator monitoring of rail condition using the handset probe 38 separate from the sensor wheel 62. The probe 38 is also connected to the processor 22.

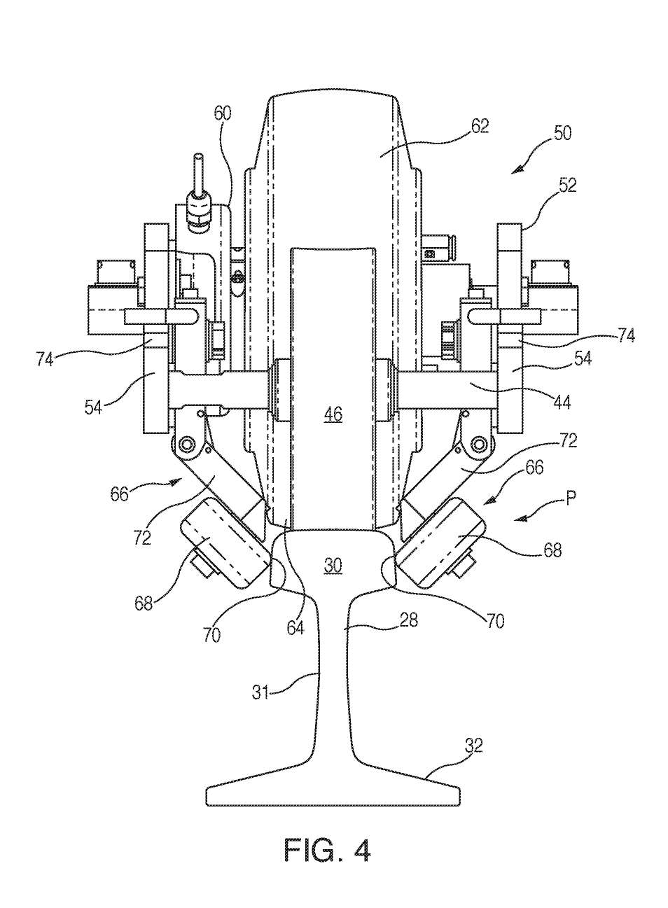

Referring now to FIGS. 4-8, a feature of the present rail capture assembly 50 is at least one and preferably two rail guides 66 on each side of the rail 28. Each rail guide 66 includes a roller 68 arranged to rotatably contact a side edge 70 of the rail head 30. Each roller 68 is secured to a pivot arm 72 secured at an end opposite the roller to a pivot point 74 on the corresponding bracket plate 54. The rail guides 66 are constructed and arranged to pivot out of engagement with the rail upon contact with an obstruction 67 on the rail, such as a switch, rail coupling or the like. As such, the guides 66 are biased to an operational position “P” and are pivotably to a retracted position “R”. Upon passing the obstacle, a biasing force on the pivot arms 72 provided by a corresponding spring (not shown) causes them to reengage the rail head 30. As such, the present rail capture assembly 50 includes six contact points, the two guide wheels 46 and the four rollers 68.

As seen in FIG. 8, the pivot arms 72 are connected together for common movement by a bar 76, which in turn is connected to a lever 78. Operator actuation of the lever causes the rollers to move from the operational position “P” to the retracted position “R”, such as when the apparatus 10 is moved from one rail to another, or during shipping of the apparatus to another work location.

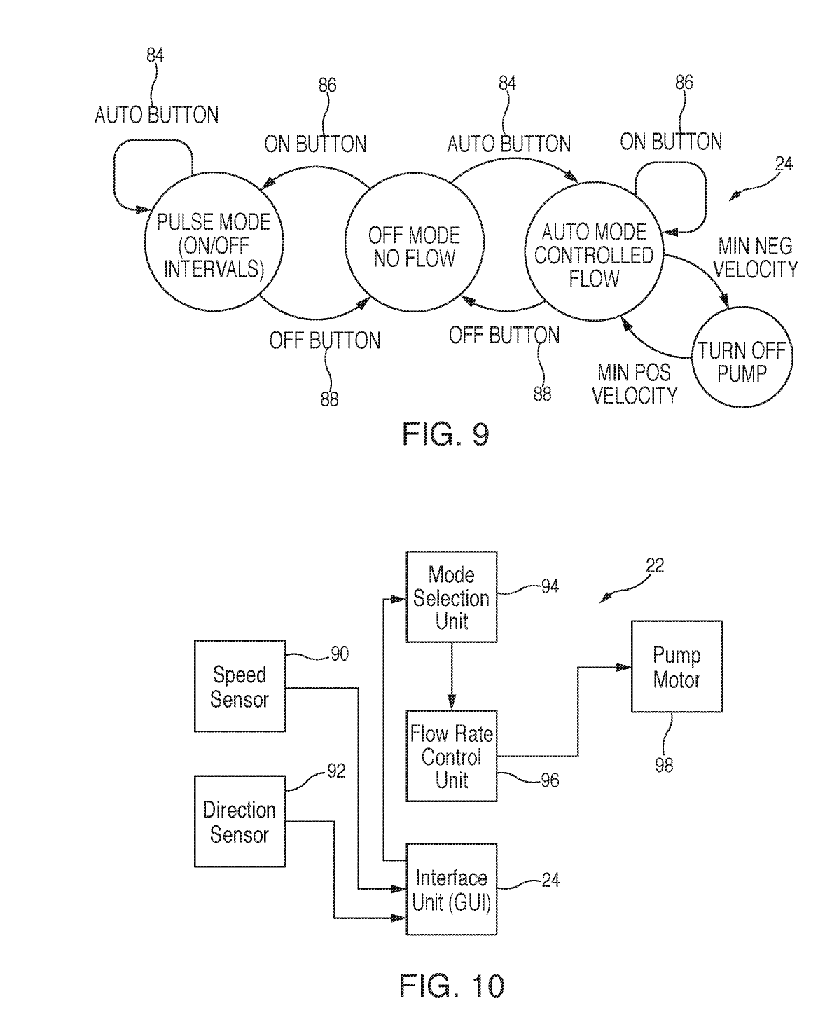

Referring now to FIGS. 9 and 10, another feature of the present apparatus 10 is that the operator can adjust the flow of liquid couplant from the GUI on the processor 22. The couplant flow rate and on/off interval is adjustable based on several variables, user presets, including speed of the apparatus, and/or environmental conditions such as ambient temperature. In the present apparatus 10, the preferred spray nozzle flow rate for applying couplant to the rail 28, via a nozzle 99, which is located in front of the ultrasonic sensor wheel 64, near the top of the rail 28. The couplant tank 36 holds approximately 5 quarts of liquid couplant. The preferred testing speed, referring to the speed at which the operator moves the apparatus 10 along the rail 28, is in the general range of 2.5 to 3.0 miles per hour. The couplant spray pump motor is preferably rated at 24 Volts DC and will run off a motor control circuit which is integrated in the DSP 22 and is powered by a battery 82 (shown hidden) which is preferably a 4 hour continuous run Lithium Manganese battery.

The processor 22 is programmed to provide multiple flow rates (typically five) and on/off interval settings selectable by the user from the GUI on the display 24. The default values are to be downloaded from the GUI via configuration file or job download. Couplant pump motor speed and on/off intervals are controlled by pulse width modulation driven from a FPGA on a One-Pass I/O board. The user selected flow rate is downloaded from the GUI and will be passed to the FPGA on the I/O board from the DSP 22.

In addition to the selectable flow rate control on the GUI, there are “AUTO” 84, “ON” 86, and “OFF” buttons 88. The ON and OFF buttons 86, 88 are used to manually apply couplant at the selected flow rate and flow interval pattern. The AUTO button 84 will engage the user selected flow rate (1 of 5) and flow interval pattern, and the detection of forward motion by monitoring an encoder associated with the sensor wheel 62 to start the pump. When in the AUTO mode of operation, and the OFF button 88 is actuated, the AUTO mode is to be exited. When the forward or reverse motion of the apparatus 10 reaches a specified minimum velocity, the pump motor will be turned off

Referring now to FIG. 10, the processor 22 is programmed so that a speed sensor 90 and a direction sensor 92 sense motion of the sensor wheel 62, then transmit sensed signals to the processor 22 for display on the GUI interface unit 24. The operator inputs on the GUI/display 24 the mode selection at 94, then an appropriate flow rate is determined at 96, so that ultimately the pump motor 98 is controlled for the appropriate distribution of couplant.

Referring again to FIGS. 1-3, the frame 12 also features a retractable blade stand 100 that is retractable or extendable by the operator. The stand 100 is configured for holding the apparatus 10 upright on the rail 28 when the apparatus is not moving.

While a particular embodiment of the present walk-behind rail condition monitoring apparatus has been described herein, it will be appreciated by those skilled in the art that changes and modifications may be made thereto without departing from the invention in its broader aspects and as set forth in the following claims.

1. A walk-behind rail condition monitoring apparatus, comprising:
a frame;
at least one handle on the frame;
a processor mounted to the frame;
a couplant tank mounted to the frame; and
a rail capture unit mounted to the frame, constructed and arranged for retaining an ultrasonic sensing wheel and including a plurality of rotating guides for maintaining alignment of the monitor on a railroad rail.

2. The monitoring apparatus of claim 1, wherein said rail capture unit includes at least one retractable roller engageable on each side of the rail.

3. The monitoring apparatus of claim 2, further including a pair of retractable rollers engageable on each side of the rail, and a pair of guide wheels, one located ahead and one behind the ultrasonic sensing wheel.

4. The monitoring apparatus of claim 2, wherein each said retractable roller is connected to a biased arm that biases the arm to an operational position.

5. The monitoring apparatus of claim 1, wherein said processor has a GUI display.

6. The monitoring apparatus of claim 5, wherein said display is configured for enabling operator control of a pump that distributes couplant from said couplant tank.

7. The monitoring apparatus of claim 5, wherein the rate of couplant dispensed is a function of at least one of the velocity of the apparatus, and the ambient temperature.

8. The monitoring apparatus of claim 5, wherein the preconfigured on/off interval of couplant dispensed is a user selectable function.

9. The monitoring apparatus of claim 1, wherein said processor is programmed for providing both A-Scan and B-Scan data, and has GPS.

10. The monitoring apparatus of claim 1, further including a mountable side handle for engagement by the operator on either a left or right side of the apparatus.

11. The monitoring apparatus of claim 1 further including a supplemental hand testing probe operable on a 12^{th} channel of the processor.

12. A walk-behind rail condition monitoring apparatus, comprising:
a frame;
at least one handle on the frame;
a processor mounted to the frame, said processor having a GUI display, is programmed for providing both A-Scan and B-Scan data, and has GPS;
a couplant tank mounted to the frame; and
a rail capture unit mounted to the frame, constructed and arranged for retaining an ultrasonic sensing wheel and including a plurality of rotating guides for maintaining alignment of the monitor on a railroad rail.

13. The monitoring apparatus of claim 12, further including a mountable side handle for engagement by the operator on either a left or right side of the apparatus.

14. The monitoring apparatus of claim 12 further including a supplemental hand testing probe operable on a 12^{th} channel of the processor.
